(19) United States
(12) Patent Application Publication
(10) Pub. No.: US 2026/0305571 A1
(43) Pub. Date: Oct. 8, 2026

(54) METHOD AND ENCLOSURE FOR REDUCING STRESS-RELATED BEHAVIOR IN DOMESTIC ANIMALS

(71) Applicant: CEVA SANTE ANIMALE, Libourne (FR)

(72) Inventors: Nicolas Guerra, LIBOURNE (FR); Miguel-Angel Sos, LIBOURNE (FR); Roger Galofre, LIBOURNE (FR)

(21) Appl. No.: 19/483,308

(22) PCT Filed: May 6, 2024
(86) PCT No.: PCT/EP2024/062480

§ 371 Date: Nov. 11, 2025

(30) Foreign Application Priority Data
May 11, 2023 (EP) 23315186.9

(51) Int. Cl. A01K 13/00; A01K 1/00

(52) U.S. Cl. CPC A01K 13/003; A01K 1/0082

(57) ABSTRACT

The present invention concerns a method for reducing stress-related behavior in domestic animals housed in an animal housing (10) such as a pen or a stall, wherein the following steps are performed:—producing at least one mist (15) of a composition comprising pheromones capable of appeasing said domestic animals, the at least one mist (15) comprising droplets having a mean diameter less than 50 μm, and preferentially comprised between 5 and 10 μm,—said at least one mist (15) being directed toward at least one direction to cover at least one area of said animal housing (10) and said mist (15) or at least one of said mists being emitted from a minimum emission height relative to the floor (12) of said animal housing (10) enabling said at least one mist (15) to reach the face of each of said domestic animals, whatever its posture.

### BACKGROUND

### Field

The present invention relates to a method for reducing stress-related behavior in several domestic animals, such as domestic mammals, housed in a same housing, such as a pen or a stall.

It further relates to an enclosure, whose original design enables to decrease stress, anxiety and aggressiveness in domestic animals.

### Brief Description of Related Developments

Pig production is one of the most important livestock sectors.

Pork accounts for about a third of all meat production in the world.

Even if meat consumptions per capita tends to decrease in high income countries, the demand worldwide continues to grow.

Thus, in order to meet consumer demand for animal protein, most of the pigs are raised under intensive conditions.

Overall, current pig production systems perform well in terms of animal health, but animal welfare can still be improved.

By way of example, smaller piglets at weaning require additional attention and care as they might struggle to adapt to weaning.

The piglets in grow-out facilities are kept indoor and raised in pens.

Typically, several piglets are housed in a same pen with feeders and waters placed in separate areas within the pen to encourage pigs to exercise.

Nevertheless, piglets are raised in smaller spaces than they would normally occupy if permitted to roam freely.

Moreover, artificial groups of piglets are created and mixing of piglets in different production stages is not rare.

This can negatively influence social interactions and cause anxiety and stress to the piglets resulting in intra-group aggressions.

Different types of aggressive behaviors have been reported.

For example, a piglet can bite a small piece of flesh of another piglet, including tail (behavior known as aggressive biting), or can pursue another piglet which can then adopt an escape behavior (behavior known as aggressive chasing), or even, can jerk its head hitting another piglet (behavior known as aggressive head-knocking).

These aggressive behaviors can be found all together when two piglets fight together, as well as a production of high-pitched vocalization.

The tasks of the facility staff, or other humans, are also rendered more complex since piglets are largely not used to novel experiences and in particular, human handling.

The anxiety and the stress of the piglets thus need to be addressed to improve the welfare of said piglets.

Their feed intake will therefore increase as well.

The same applies to ruminants.

It is known from the prior art to use composition of pheromones to reduce stress and anxiety in animals.

By definition, pheromones are chemicals released by a living body that send information and thus cause a predictable reaction by another individual of the same species.

Said composition of pheromones can be implemented in a number of different ways depending on the animal, whose behavior is intended to be modified.

For example, it can be applied on an object such as carpet, a wearable device such a collar, . . . or simply applied directly to the coat or skin of the animal for example as a gel, lotion, shampoo or cream.

The administration can also be carried out by diffusion of the composition of pheromones or spraying in the facial region or on the head of the animal.

Although being susceptible to give good results, it is noted that, to the best knowledge of the applicant, said known methods of administration of a composition of pheromones are only directed to the treatment of a single animal.

However, the known methods are clearly not adapted to the appeasement of a plurality of domestic animals such as pigs or piglets.

There is therefore a pressing need for a method and enclosure having an original design that would effectively alleviate stress-related symptoms in a plurality of domestic animals.

### OBJECT OF THE INVENTION

The present invention aims to mitigate the drawbacks of the prior art by providing a method and an enclosure for reducing stress-related behavior in a plurality of domestic animals, that are simple in their design and in their operating mode, reliable and capable of administering at the same time, an effective amount of a pheromone composition with appeasing effect to said domestic animals.

Another object of the present invention is to provide such a method and enclosure that are capable of accompanying part of the growth of said domestic animals if necessary or operating with domestic animals that are not of a predefined average size.

Still another object of the present invention is to provide a method for raising domestic animals in stalls, that enhances their welfare by reducing effectively their stress and anxiety all along their stay in said stalls.

These and other objects are achieved by the present invention as evidenced by the brief description of the invention, description of the preferred embodiments and the claims.

### BRIEF DESCRIPTION OF THE INVENTION

To this effect, the invention relates to a method for reducing stress-related behavior in domestic animals housed in an animal housing such as a pen, a stall or a livestock vehicle.

According to the invention, the following steps are performed:
producing at least one mist of a composition comprising pheromones capable of appeasing said domestic animals, the at least one mist comprising droplets having a mean diameter less than fifty (50) μm, and preferentially comprised between five (5) and ten (10) μm,
said at least one mist being directed toward at least one direction to cover at least one area of said housing and at least a part of said at least one mist or at least one of said mists being emitted from a minimum emission height relative to the floor of said animal housing, enabling said at least one mist to reach the face of each of said domestic animals, whatever its posture.

The posture of the domestic animal can be an upright position, a laying down position, or in movement.

Advantageously, one seeks than these droplets reach, directly or by fallout, the face (nasal cavities and the mouth) of said domestic animal so that droplets reach the vomeronasal organ of said domestic animal via inhalation.

By way of example, a first mist can be emitted from a minimum emission height relative to the floor of said animal housing, the mist generating unit emitting said first mist being elevated relative to the floor of said animal housing and being arranged to be placed above any of said domestic animals positioned in said animal housing, so that the droplets of said first mist reaches, directly or by fallout, the face of each of said domestic animals whatever its posture. A second mist can be emitted from another mist generating unit positioned relative to said floor at a maximum height comprised between the floor level and said minimum emission height and being oriented towards the eyes and nose of said domestic animals. The combination of both mists enables to treat all the domestic animals present in said animal housing.

Of course, these mist generating units might be replaced by a single mist generating unit emitting a mist having at least two components of mist.

Of course, a single mist can be enough to treat all the domestic animals present in said animal housing depending on the power of the mist generating unit.

The present method can be used in any domestic animal, but it is desirable for appeasing domestic animals advantageously selected from the group consisting of pigs, piglets, cows, horses, cats, dogs, . . . .

It should be noted that the present method is particularly effective in appeasing a plurality of domestic animals at once, and therefore reducing stress and anxiety that result from intensive livestock production.

The term «pheromone» as used herein refers to any compound that mimics certain naturally occurring pheromones that have a behavioral impact, such as a calming or appeasing effect, on animals. It includes any naturally occurring pheromones, said naturally occurring pheromones are one or more secreted compounds by an organism of a specific species which entails a foreseeable reaction (such as for example a calming effect) to another animal of the same species or another species. As specified earlier, pheromones will be used herein in a large sense, i.e. any naturally or non-naturally occurring compound that have a behavioral impact on non-human animals.

According to an advantageous embodiment of this method for reducing stress related behavior in domestic animals, the said or at least one mist is generated by a mist generating unit that is supported by, or attached to, a construction element or a rigid support structure adapted to support a load.

This construction element or rigid support structure can be part of said animal housing or be placed in the immediate vicinity of said animal housing.

By way of illustration, said construction element or said rigid support structure can be chosen from the group comprising a wall, a dividing wall, a ceiling, . . . or be a structural elongated component designed for load supporting such as a mast, a pillar or a column, . . .

Of course, the said or at least one of said mist generating units can be supported by a rigid support element such as a frame that is linked to or attached to said construction element or rigid support structure.

In other words, each mist generating unit is not worn directly by an animal ensuring that the mist or said plurality of mists can reach the faces of all the domestic animals placed within the animal housing, whatever its posture.

According to an advantageous embodiment of this method for reducing stress related behavior in domestic animals, the mean height of the domestic animal with a high head posture being H, the minimum emission height is of at least 1.2 H, and preferentially of at least 1.5 H, and even more preferentially of at least 2.5 H, from the floor of said animal housing.

This ensures that the domestic animals positioned within the range of action of the mist generation unit, receive all at the same time an appropriate dose of pheromones by fallout.

Moreover, these domestic animals being not disturbed by, or in contact with, any physical jet, they are not undergoing any further stress.

By way of example, said mist or at least one of said mists is emitted from a height of at least 1.2H, and preferentially a height of at least 1.5 H, and even more preferentially of at least 2.5 H, from the floor of said animal housing.

Preferentially, this minimum emission height can be adjusted for example to take into account one or several animals which would present a height above the average or the growth of said animals during their stay in said housing.

For example, the mist generating unit emitting said mist or one of said mists can be mounted on a track and be vertically adjustable within said track to allow the minimum emission height relative to the floor of the animal housing to be adjusted. This change in height might be remotely controlled.

According to another advantageous embodiment of this method for reducing stress related behavior in domestic animals, the faces of said domestic animals within the animal housing are directly subjected to, either immediately or by fall-out, to said droplets.

In other words, the faces of these domestic animals within the animal housing are directly subjected to the droplets of said mist or at least one of said mists, either immediately or by fallout on its face, but before said droplets have touched the ground or floor of said animal housing by falling back.

According to another advantageous embodiment of this method for reducing stress related behavior in domestic animals, the at least one mist covers the entire animal housing.

According to another advantageous embodiment of this method for reducing stress related behavior in domestic animals, the at least one mist covers an angular sector of said animal housing comprised between 0° and 360°.

According to an advantageous embodiment of this method for reducing stress related behavior in domestic animals, the at least one mist is accelerated so as to increase its projection range within said housing.

According to a further advantageous embodiment of this method for reducing stress related behavior in domestic animals, the at least one mist is generated by nebulization by one or more nebulizers.

Preferentially the at least one mist is generated by one or more humidifiers, each comprising a ventilator.

According to a further advantageous embodiment of this method for reducing stress related behavior in domestic animals, the at least one mist comprises 50 to 80% by weight of droplets having a mean diameter less than 50 μm, the rest of said droplets having a mean diameter between fifty (50) and one hundred (100) micrometers.

Alternatively, the at least one mist comprises 50 to 80% by weight of droplets having a mean diameter less than ten (10) μm, the rest of said droplets having a mean diameter between ten (10) and one hundred (100) micrometers.

According to a further advantageous embodiment of this method for reducing stress related behavior in domestic animals, the following additional steps are carried out:
detecting the position of said domestic animals in said animal housing, and
generating said at least one mist in direction of the position of the domestic animals.

This targeting enables to limit the loss of pheromone composition.

According to a further advantageous embodiment of this method for reducing stress related behavior in domestic animals, said at least one mist is emitted at an instant t₀ and for a duration T, which ends before a later instant t₁ at which an action is programmed such as the visit of an operator.

It was thus observed that domestic animals were not disturbed by the intervention of the operator.

According to a further advantageous embodiment of this method for reducing stress related behavior in domestic animals, the mist generation frequency of the at least one mist is every hour, or preferentially every thirty (30) minutes.

The present disclosure also relates to a method for raising domestic animals, comprising the following steps:
providing an animal housing with multiple areas such as pens, sized according to the requirements of the livestock farming of said domestic animals,
placing several domestic animals in each of said areas,
producing at least one mist in the animal housing from a composition comprising pheromones capable of appeasing said domestic animals, the at least one mist comprising droplets having a mean diameter less than 50 μm, and preferentially comprised between 5 and 10 μm, and
emitting at least a part of said at least one mist or at least one of said mists from a minimum emission height relative to the floor of the corresponding areas to enable said at least one mist to reach the face of each of said domestic animals within said areas, whatever its posture.

By way of example, said domestic animals are aged of a predetermined number of days after weaning.

The method for raising domestic animals, comprises the following steps:
providing an animal housing with multiple areas such as pens, sized according to the requirements of the livestock farming of said domestic animals,
placing several domestic animals in each of said areas, and
the steps of the method for reducing stress-related behavior in domestic animals housed in an animal housing as described above.

According to an advantageous embodiment of the present method for raising domestic animals, each mist is emitted so as to cover the whole area of its corresponding area.

By way of example, this area can be an enclosed area.

According to another advantageous embodiment of the present method for raising domestic animals, the mean height of the domestic animal with a high head posture being H, the minimum emission height is of at least 1.2 H, and preferentially of at least 1.5 H, and more preferentially of at least 2.5 H, from the floor of said corresponding areas.

By way of example, said mist or at least one of said mists is emitted from a height of at least of 1.2 H and preferentially of at least 1.5 H and even more preferentially of at least 2.5 H from the floor of said corresponding areas.

According to a further advantageous embodiment of the present method for raising domestic animals, the mist generation frequency within each area is every hour, or preferentially every thirty (30) minutes.

According to a further advantageous embodiment of the present method for raising domestic animals, brightness, temperature and/or noise in said enclosed areas are controlled to participate in reducing stress-related behavior in said domestic animals.

The present disclosure also relates to an enclosure, such as a pen or a livestock vehicle, defining an area capable of housing domestic animals. According to the present invention,
said enclosure comprises one or more mist generating units for generating a mist from a composition containing pheromones capable of appeasing said domestic animals,
each mist generating unit being configured to generate droplets having a mean diameter less than 50 μm, and preferentially comprised between 5 and 10 μm, and
said or at least one of said mist generating units is arranged within the enclosure or in the vicinity of said enclosure such that, in a coverage zone of said corresponding unit, the mist is emitted from a minimum emission height relative to the floor of said area to enable said mist to reach the face of each of said domestic animals placed in its coverage zone, whatever its posture.

The number of mist generating units required will depend on the range of action of the unit, as well as the type of domestic animals whose behavior is intended to be modified.

Advantageously each mist generating unit should be capable of delivering a sufficient quantity of pheromone to appease the domestic animals placed in its range of action. If a higher amount of pheromone per animal is needed at a given time, this can be achieved by changing the concentration placed in the mist generating unit.

According to an advantageous embodiment of said enclosure, the said or at least one of said mist generating units is supported by, or attached to, a construction element or a rigid support structure adapted to support a load.

This construction element or rigid support structure can be part of said enclosure or be placed in the immediate vicinity of said enclosure.

By way of illustration, said construction element or said rigid support structure can be chosen from the group comprising a wall, a dividing wall, a ceiling, . . . or be a structural elongated component designed for load supporting such as a mast, a pillar or a column, . . .

Of course, the said or at least one of said mist generating units can be supported by a rigid support element such as a frame that is linked to or attached to said construction element or rigid support structure.

According to an advantageous embodiment of said enclosure, the enclosure comprises a configurable management unit to control each mist generating unit.

Preferentially, said management unit is configured to activate each mist generating unit at a regular interval of time. For example, mist generation frequency within the enclosure is every hour, or preferentially every thirty (30) minutes.

According to a further advantageous embodiment of said enclosure, the mean height of the domestic animal with a high head posture being H, each mist generating unit is placed at a height of at least 1.2 H and preferentially of at least 1.5 H and even more preferentially of at least 2.5 H from the floor of said enclosure.

Advantageously, said height is adjustable.

If adjustable, the height of the mist generating unit can advantageously be controlled remotely.

Thus, said mist or at least one of said mists is emitted from above said domestic animals and falls towards the ground, or floor of said area, while covering a predetermined coverage area.

According to a further advantageous embodiment of said enclosure, at least one of said mist generating units is a nebulizer and preferentially a humidifier comprising a ventilator.

According to a further advantageous embodiment of said enclosure, the mist generating unit can comprise a pulsed gas jet emitter, such as a fan, in order to project the mist.

The mist generating unit can comprise a temperature controller of the pulsed gas jet.

### BRIEF DESCRIPTION OF THE DRAWINGS

Other advantages, purposes and particular characteristics of this invention shall result from the following description, provided for the purposes of explanation and in no way limiting, with respect to the annexed drawings, wherein:

FIG. 1 is a schematic representation of an enclosure according to one particular embodiment of the present invention, said enclosure housing a plurality of piglets;

FIG. 2 is a partial view of the enclosure illustrated in FIG. 1, showing the mist generation unit positioned within said enclosure and the coverage zone of the generated mist;

FIG. 3 is a schematic representation of an enclosure according to another particular embodiment of the present invention;

### DETAILED DESCRIPTION OF EMBODIMENT OF THE INVENTION

The drawings and description below contain, for the most part, elements of certain character. They will therefore possibly not only serve to better understand the present invention, but also contribute to the definition thereof, where appropriate.

Firstly, it will be noted that the figures are not to scale.

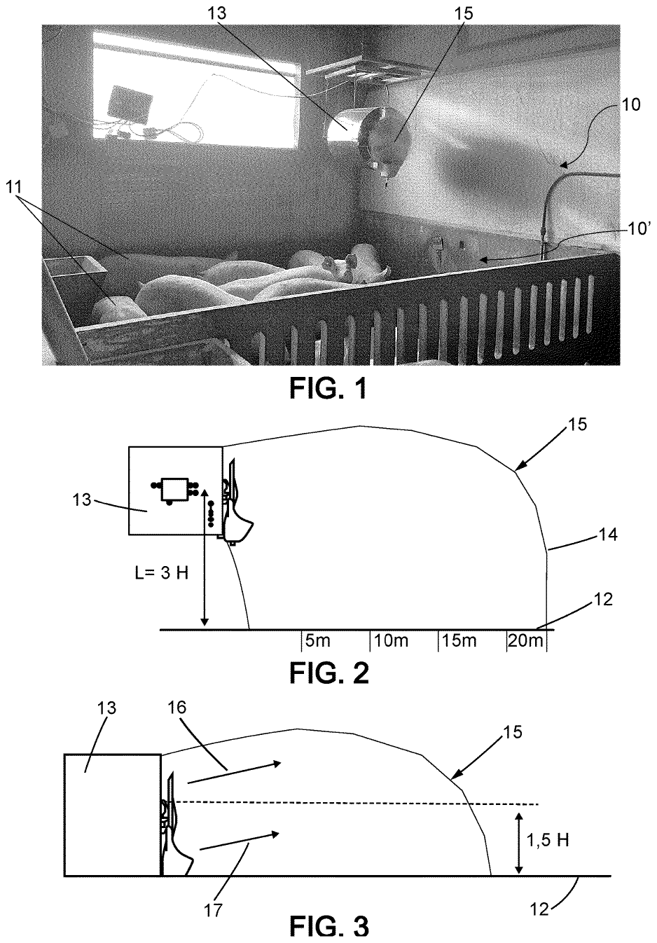

An enclosure 10 such as a pen, for raising a plurality of piglets 11 according to a particular embodiment of the present invention will now be described with reference to FIGS. 1 and 2.

This enclosure 10 comprises a floor 12, side walls for example rigidly built. The enclosure can comprise a front wall that is preferably in the form of a sliding door (not represented).

The enclosure 10 is rectangular. The enclosure 10 is sized to provide enough space for defining distinct areas 10′ for feeding, bedding and defecating. The distinct areas 10′ can be adjacent.

This enclosure 10 contains a single mist generating unit 13 for generating a mist by nebulization of a composition containing pheromones capable of appeasing said piglets 11.

Said mist generating unit 13 is positioned above the piglets 11 in said enclosure 10, being supported by the ceiling of said pen.

Said mist generating unit 13 has a range of action 14 covering the whole area delimited by said enclosure 10 so as to administrate at the same time, said pheromones to every piglet 11 placed within the enclosure 10.

Said mist generating unit 13 is here a humidifier comprising a ventilator, and more preferentially a centrifugal ventilator. The humidifier works with a rotating disc that sprays the composition without the need of nozzles.

Alternatively, the mist generating unit 13 can be an ultrasonic nebulizer, for example comprising a piezo electric device.

From said composition, the mist generating unit 13 produces a mist 15 comprising droplets having a mean diameter less than 50 μm.

The mean height of the piglets with a high head posture being H, the mist generating unit 13 is elevated relative to the floor 12 of said enclosure 10 so that the mist 15 is emitted from a height of about L=3 H from the floor 12. The height L is here of the order of 2.5 m above the floor.

The mist 15 is therefore emitted at a height L relative to the floor of said enclosure that enables said droplets to reach by fallout the face of each of said domestic piglets placed in its coverage zone, whatever its posture.

FIG. 3 is a schematic representation of an enclosure according to another particular embodiment of the present invention.

The items shown in FIG. 3 having the same references as the ones illustrated in FIGS. 1 and 2 represent the same objects, which will not be described again hereunder.

The mist generating unit 13 represented in FIG. 3 differs from the one illustrated in FIGS. 1 and 2 in that it comprises two ventilators, aligned vertically, and producing each a main component 16, 17 of the mist 15.

The mist 15 that is emitted by said mist generating unit 13, is therefore the result of the combination of these two main mist components 16, 17 that are inclined.

A first main component 16 is oriented such that part of the mist 15 propagates before its fall out, above a minimum emission height of 1.5 H relative to the floor 12 level of the enclosure 10 and the second main component 17 is propagates essentially under this minimum emission height but is oriented towards the eyes and the nose of the plurality of piglets contained within enclosure 10.

1. Method for reducing stress-related behavior in domestic animals housed in an animal housing, wherein the following steps are performed:
producing at least one mist of a composition comprising pheromones capable of appeasing said domestic animals,
said at least one mist comprising droplets having a mean diameter less than 50 μm;
said at least one mist being directed toward at least one direction to cover at least one area of said animal housing and at least a part of said at least one mist or at least one of said mists being emitted from a minimum emission height relative to the floor of said animal housing enabling said at least one mist to reach the face of each of said domestic animals, whatever its posture.

2. Method for reducing stress-related behavior according to

1. wherein the mean height of the domestic animal with a high head posture being H, the minimum emission height is of at least 1.2 H from the floor of said animal housing.

3. Method for reducing stress-related behavior according to claim 1, the faces of said domestic animals within the animal housing are directly subjected, either immediately or by fall-out, to said droplets.

4. Method for reducing stress-related behavior according to claim 1, wherein the at least one mist is accelerated so as to increase its projection range within said animal housing.

5. Method for reducing stress-related behavior according to claim 1, wherein the at least one mist is generated by nebulization by one or more nebulizers.

6. Method for reducing stress-related behavior according to claim 1, wherein the at least one mist comprises 50 to 80% by weight of droplets having a mean diameter less than 50 μm, the rest of said droplets having a mean diameter between 50 and 100 μm.

7. Method for reducing stress-related behavior according to claim 1, wherein the at least one mist comprises 50 to 80% by weight of droplets having a mean diameter less than 10 μm, the rest of said droplets having a mean diameter between 10 and 100 μm.

8. Method for reducing stress-related behavior according to claim 1, wherein the additional steps are performed:
detecting the position of said domestic animals in said animal housing, and
generating said at least one mist in direction of the position of the domestic animals.

9. Method for reducing stress-related behavior according to claim 1, wherein the said or at least one mist is generated by a mist generating unit that is supported by, or attached to, a construction element or a rigid support structure adapted to support a load.

10. Method for raising domestic animals, comprising the following steps:
(a) providing an animal housing with multiple areas sized according to the requirements of the livestock farming of said domestic animals,
(b) placing several domestic animals in each of said areas,
(c) producing at least one mist in the animal housing from a composition comprising pheromones capable of appeasing said domestic animals, the at least one mist comprising droplets having a mean diameter less than 50 μm, and
(d) emitting at least a part of said at least one mist or at least one of said mists from a minimum emission height relative to the floor of the corresponding areas to enable said at least one mist to reach the face of each of said domestic animals within said areas whatever its posture.

11. Method for raising domestic animals according to claim 10, wherein the mean height of the domestic animal with a high head posture being H, the minimum emission height is of at least 1.2 H from the floor of said animal housing.

12. Enclosure such as a pen or a livestock vehicle, defining an area capable of housing domestic animals, wherein
said enclosure comprises one or more mist generating units for generating a mist from a composition containing pheromones capable of appeasing said domestic animals,
each mist generating unit being configured to generate droplets having a mean diameter less than 50 μm, and
said or at least one of said mist generating units is arranged within the enclosure or in the vicinity of said enclosure such that, in a coverage zone of said corresponding unit, the mist is emitted from a minimum emission height relative to the floor of said area to enable said mist to reach the face of each of said domestic animals placed in its coverage zone, whatever its posture.

13. Enclosure according to claim 12, wherein the said or at least one of said mist generating units is supported by, or attached to, a construction element or a rigid support structure adapted to support a load.

14. Enclosure according to claim 12, wherein at least one of said mist generating units is a nebulizer.

15. Enclosure according to claim 12, wherein the mean height of the domestic animal with a high head posture being H, each mist generating unit is placed at a height of at least 1.2 H from the floor of said enclosure.
